(19) United States
(12) Patent Application Publication
(10) Pub. No.: US 2024/0104400 A1
(43) Pub. Date: Mar. 28, 2024

(54) DERIVING AUGMENTED KNOWLEDGE

(71) Applicant: INTERNATIONAL BUSINESS MACHINES CORPORATION, ARMONK, NY (US)

(72) Inventors: Ruchi Mahindru, Elmsford, NY (US); Ashish Ghodasara, Cary, NC (US); Harshit Kumar, Delhi (IN)

(21) Appl. No.: 17/946,639

(22) Filed: Sep. 16, 2022

(51) Int. Cl. G06N 5/02

(52) U.S. Cl. CPC G06N 5/022

(57) ABSTRACT

Deriving augmented knowledge defining a knowledge base by extracting entities from a plurality of heterogeneous data sources; and augmenting the extracted entities; and utilizing an augmented entity to enhance a user activity.

### FIELD OF THE INVENTION

The disclosure relates generally to deriving knowledge from disparate data sources. The invention relates particularly to building an augmented knowledge base from entities/metadata spread across multiple heterogeneous siloed data sources.

### BACKGROUND

IT Support Data may be distributed in various repositories e.g. user guides, technotes, forums, tickets etc. As a result, problem diagnosis step/resolutions/context may be spread across multiple knowledge sources. Available solutions may crawl the various knowledge sources and bring them together for resolution retrieval yielding segregated results.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the derivation of augmented information from Information Technology support data.

Aspects of the invention disclose methods, systems and computer readable media associated with deriving augmented knowledge by defining a knowledge base by extracting entities from a plurality of heterogeneous data sources, augmenting the extracted entities; and utilizing an augmented entity to enhance a user activity.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 provides a block diagram depicting an operational sequence, according to an embodiment of the invention.

FIG. 4 illustrates an augmented knowledge derivation example, according to an embodiment of the invention.

FIG. 5 depicts a cloud computing environment, according to an embodiment of the invention.

FIG. 6 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Distributed, heterogenous Information Technology (IT) operations data, in the form of tickets, resolution articles, change tickets, resolution taxonomies, etc., which may be available in data silos. As a result, multiple different data silos contain the data associated with problem diagnosis steps, problem resolutions, and problem context.

Known solutions, able to crawl the various knowledge sources and bring them together for resolution retrieval, may be available, but such systems return segregated results. This creates a burden on the user to go through multiple results to retrieve the information that may be relevant for the problem diagnosis. Even going through multiple results may not provide satisfactory results. Users may still miss relationships between data elements spread across multiple sources. Further, this is highly time-consuming and subjective as it depends on the skill set of a user who may easily miss information that a more skilled user may be able to exploit.

Each unstructured dataset may contain certain entities, for example, ticket data may contain problem description, severity, category, sub-category, product version, and consistently referenced diagnostics/resolutions URL (uniform resource locator). Resolution articles may contain product names, product versions, and operating system version information. Change ticket data may contain change request ids, change descriptions, components being updated, configuration changes, or new developments. Resolution taxonomies (if any exist) may contain category and sub-category data that is associated with the resolution document. Such segregated data needs to be processed and displayed as ready-to-use knowledge, for faster and more effective incident remediation (e.g., query formulation, query completion, faceted search . . . ). Disclosed embodiments enable an end-to-end system that takes multiple datasets and augments them together in AIOps, yielding an integrated usable output applicable to augmenting numerous user activities.

Disclosed embodiments deal with “noisy” unstructured data, such as logs, timestamps, comments, opinions, diagnosis, and symptoms, shared by the various parties involved (like client (expert/non-expert), subject matter experts (SMEs), developers, testers, operations, site reliability engineers (SREs), Support Engineers, etc.). The use of a domain ontology enables mapping different entities (lexically different but semantically similar) arriving from multiple corpora. Additionally, disclosed embodiments employ domain rules that are specific to various stages of the product lifecycle namely development, operations, and support (for example) to map entities as used in a different context.

Aspects of the present invention relate generally to knowledge derivation systems and, more particularly, to knowledge derivation across multiple heterogeneous data silos. In embodiments, a knowledge derivation system receives data from multiple heterogeneous data silos, extracts key entities from each of the disparate data sources, the systems augment the overall data set by associating entities across multiple sources by normalizing the data and mapping the key entities using semantic embeddings of the entities from an overall domain ontology provided by SMEs. According to aspects of the invention, the knowledge derivation system automatically and dynamically adjusts the semantic embeddings and domain ontology through system use and active learning, improving entity extraction and association. In this manner, implementations of the invention learn and continually adjust the domain ontology such that entity extraction and overall data augmentation improves over time and use. The domain ontology contains the relationships and policies between different known entities spanning multiple dimensions across heterogeneous data sources.

In an embodiment, methods define one or more inclusion policies according to resolution URL patterns detected amongst the input data for a particular problem/message code. In an embodiment, methods define one or more prioritization policies according to a source type for an extracted entity, e.g., technotes—1 priority, product documentation—2 priority, forum—3, external source—4, etc. In an embodiment, methods define knowledge bases/retrieval engines of importance for resolution extraction according to the results retrieved from various knowledge bases/retrieval engines.

In accordance with aspects of the invention, methods automatically augment knowledge derivation from an overall corpus of heterogenous data silos, such as data silos associated with IT support data. The methods include defining a knowledge base by receiving heterogeneous IT support or other data, extracting key entities from the heterogeneous data, augmenting key entities with associated metadata across disparate sources according to relationships and policies of an overall domain ontology, ranking augmented key entity problem resolutions together with problem resolution explanations. Further by then processing one or more user activities, such as user input queries, by identifying a source of the query, extracting at least one key entity from the query language, identifying content from the knowledge base associated with the extracted key entity, and formulating an input query according to the input source and the associated context, retrieving results from the knowledge base for the formulated query, ranking the results according to the problem resolutions, and providing a user with the ranked results and explanations.

Aspects of the invention provide an improvement in the technical field of knowledge derivation systems. Conventional knowledge derivation systems utilize a homogenous data source and return results segregated according to the data sources. In many cases, users must review segregated results for potentially relevant information related to problem resolutions. Such efforts consume valuable time and yield subjective results, dependent upon the skill of the individual user in reviewing the results. In some cases, users might have more skill in determining useful results for their problem, in some cases, users may not have such skill. Implementations of the invention automatically leverage SME knowledge by utilizing a dynamic knowledge domain that changes over time and is optimized to provide ranked problem resolution results. This provides the improvement of achieving the desired outcome for the user (i.e., providing problem resolutions, independent of the user's particular skill level for discriminating among potential problem resolutions).

Aspects of the invention also provide an improvement to computer functionality. In particular, implementations of the invention are directed to a specific improvement to the way knowledge derivation systems operate, embodied in the continually adjusted knowledge domain relationships and policies across multiple heterogeneous datasets. In embodiments, the system adjusts the knowledge domain relationships and policies with each query and associated results, such that the knowledge domain relationships and policies utilized for the next query differ from the relationships and policies applied to the current question. As a result of adjusting the knowledge domain for the next query based on the results for the current query, the system alters the results so that the system will provide an answer for the next query. In this manner, embodiments of the invention affect how the knowledge derivation system functions (i.e., the knowledge domain reflecting changes in the system knowledge between one query and the next.

As an overview, a knowledge derivation system is an artificial intelligence application executing on data processing hardware that answers queries pertaining to a given subject-matter domain presented in natural language. The disclosed knowledge derivation system receives inputs from various heterogeneous sources including input over a network, a corpus of electronic documents or other data, data from a content creator, information from one or more content users, and other such inputs from other possible sources of input. Data storage devices store the heterogeneous corpora of data. The system extracts key entities from the current query and retrieves data associated with that key entity from across the multiple heterogeneous corpora. Retrieved data may be ranked according to a contextual relationship with the instant query and presented to the user. The relationships and policies held in the knowledge domain for respective entities may be altered by the system over time as the system receives additional data, or in association with relationships identified due to queries.

In an embodiment, one or more components of the system can employ hardware and/or software to solve problems that are highly technical in nature (e.g., defining a knowledge domain, processing an input query using the knowledge domain, retrieving results associated with the query, ranking the retrieved results, etc.). These solutions are not abstract and cannot be performed as a set of mental acts by a human due to the processing capabilities needed to facilitate knowledge derivation across heterogeneous data sets, for example. Further, some of the processes performed may be performed by a specialized computer for carrying out defined tasks related to knowledge derivation. For example, a specialized computer can be employed to carry out tasks related to IT support knowledge derivation, or the like.

In an embodiment, methods for deriving augmented knowledge from IT support data, include utilizing a computer system for defining a knowledge base. In this embodiment, the methods define the knowledge base by extracting a plurality of entities, such as problems, problem resolutions, or other key entities, from multiple heterogeneous corpora, including problem case or ticket data, support documents detailing problem resolutions, historic log data relating previous problems and associated resolutions, and system search query logs providing previous search/results combinations.

In an embodiment, methods may extract entities from product support documents, including sentiment data such as likes and dislikes, but such product support documents may be missing relevant context regarding the problem being solved for the entity data. Methods may extract entity data including, but not limited to, “title”: “<title of the document>”; “symptom description”: “<symptom is being addressed>”; “resolution”: “<diagnostic steps and actions to be taken>”; “resolution_url”: https://123; and “classification”:{“category”,“sub-category”, “operating_system”: rhel, xp, “product_version”, “product description”, “last_modified_date”, “document_popularity” }.

As an example, a method may extract data related to a particular message code, CKSIT54588E, from a technical support document, the extracted data includes descriptions of log template for the message code, “The messaging engine's unique identified (ME UUID) does not match that found in the data store”, as well as a root cause explanation for the error. The support document may further provide a product, product version, and operating system information associated with the message code.

In an embodiment, methods may extract entity data from historic case data, which is a record of problems reported by the customer, diagnostic steps provided by the support engineers, and the resolution applied to resolve the problems. Entity data that may be extracted from historic case data may include user reviews such as user up/down votes, and context data regarding the problem being solved. Method may extract entity data including, but not limited to “symptom”: “System hang”; “operating_system”: “redhat I windows”; “product_version”:“8.0”;“product”: “websphere”; and “resolution_url”: https://123. As an example, historic log data may yield product, product version, and operating system data, in addition to corresponding message codes for prior system problems.

In an embodiment, methods may extract entity data from historical search query logs, such data associated with the query and the problem context or other facets from the query, as well as including associated ranked lists of problem resolution URLs. For example, a query log search may yield a collection of queries with results having a common message code, enabling association of that included message code across a range of other entities also included in the query results.

In an embodiment, the method augments the extracted entities by combining the entities extracted from each of the product documents, the historical case data, and the historical search query logs in the augmented knowledge base for use in completing partial user queries, reformulating user queries with augmented entity data, supporting a faceted search based upon the augmented entity data, providing search results explanations according to the augmented data, and re-ranking initial search results according to associations from the augmented entity data.

As an example, an augmented entity entry may comprise “<last modified_date>”, “<document_popularity>”, <System hang|app unresponsive|server out of memory>, rhel;redhat|windows;xp, and websphere version: 8.0|9.0, extracted from a combination of product support documents, historical case log data, and historical search query log data.

The methods evaluate the heterogeneous corpora utilizing natural language processing (NLP), or natural language understanding (NLU). Disclosed embodiments can perform natural language processing for extraction of NLP output parameter values from received system data as described above. NLP/NLU includes performing one or more topic classification process that determines topics of messages and outputs one or more topic NLP output parameter value, a sentiment analysis process which determines sentiment parameter value for a message, e.g., polar sentiment NLP output parameters, “negative,” “positive,” and/or non-polar NLP output sentiment parameters, e.g., “anger,” “disgust,” “fear,” “joy,” and/or “sadness” or other classification processes for output of one or more other NLP output parameter values, e.g., one of more “social tendency” NLP output parameter or one or more “writing style” NLP output parameter, and/or one or more part of speech NLP output parameter value. Part-of-speech tagging methodologies can include the use of, e.g., Constraint Grammar, Brill tagger, Baum-Welch algorithm (the forward-backward algorithm), and the Viterbi algorithm which can employ the use of the Hidden Markov models. Hidden Markov models can be implemented using the Viterbi algorithm. The Brill tagger can learn a set of rule patterns and can apply those patterns rather than optimize a statistical quantity. Applying natural language processing can also include performing sentence segmentation which can include determining where a sentence ends, including, e.g., searching for periods, while accounting for periods that designate abbreviations.

In an embodiment, the methods augment the extracted entity data with associated metadata, such as, for a ticket/case—ticket number, response time, product name, product version, severity, ticket, ticket body; for a resolution taxonomy—ticket description, resolution title, resolution URL, problem category, problem sub-category; for product content—message codes, such as a unique alpha-numeric identifier for each problem, problem resolution, etc., message strings, resolution descriptions, resolution URL; and for log data—time stamps, log lines—containing a message code. In an embodiment, the methods formulate an embedding for the entities including the NLP results and the metadata. The methods then associate “same-as” entities across data sources according to the semantic embeddings and separation distances between pairings for semantic embeddings. For example, the methods associate entities that have the same semantic embeddings but different entity names, as well as associating entities having the same entity names and differing semantic embeddings.

A similarity between embedding pairings, based on the entity name, NLP outputs, and metadata. Examples of methods of determining the similarity of text-based documents include Jaccard distance, Cosine distance, Euclidean distance, Relaxed Word Mover's Distance, and may utilize term frequency-inverse document frequency (tf-idf) techniques. A person of ordinary skill in the art may apply other techniques of determining similarity between page pairings of a document other than those presented, herein, and not deviate from, or limit the features of embodiments of the present invention.

Given a unique extracted problem identifier, the methods query the defined set of knowledge bases/retrieval engines. For example, most hardware/software products have unique problem identifiers in form of message codes or a specific set of technical key phrases describing the possible problems. For each message code (unique problem identifier), the methods extract resolution URLs from case data as the primary metadata, as such information is a result of careful/expert-driven problem diagnosis, where the resolution URLs are a pointer to a webpage containing the actual solution. Where case data, also known as ticket data is a complete record of problems reported by the customer including entire interactions between the support engineer and the user in the case body to capture the problem determination and resolution steps. Occasionally, support engineers may even document the final resolution in a special field called resolution description. Additionally, there may be context information in the case data such as product version, operating system, etc. The methods enrich the resolution data extracted based on available manually curated knowledge repositories like problem and resolution taxonomy context.

The methods normalize the resolution URLs. Case data may have spanned across the past couple of years and some of the URLs may have become stale or redirected. URLs may also appear in different formats as the systems hosting these URLs may have transitioned through their changes. Therefore, the systems/methods must check which URLs are still alive and what the final redirect URL that should be used. Otherwise, the URL count would be distributed across the variations of the same URL. The systems/methods annotate the resolution URLs with the source type and source priority data. The systems/methods compute the count of unique resolution URLs across the result set. The systems/methods then rank (for relevance/importance etc.) the results based on the unique problem identifier, presence in resolution description, count, source priority, etc. The methods/systems then store the aggregated resolution data in a knowledge domain ontology for retrieval, along with context for explainability/profiling of the resolutions.

In an embodiment, the methods process a new query associated with a user seeking information relevant to resolving a current user problem in the system. In this embodiment, the methods extract entity and context data from the query using NLP methods. The methods then retrieve data from the previously defined domain ontology associated with the extracted entity and context data of the query. Additional data for the query may include an identified source associated with the query.

In an embodiment, the methods rank the retrieved results associated with the extracted context and entity data in view of the source data and provides the ranked results to the query originator via a system output device such as a display or printer. In this embodiment, the methods rank the results according to at least one of results order, results context, and user feedback relating to the results.

In an embodiment, methods use the retrieved results from the domain ontology to reformulate the query using highly ranked additional entity and context data from the results. As an example, the methods expand the original query by adding retrieved metadata associated with a unique problem identifier contained in the original query. The methods then retrieve a new set of results associated with the reformulated query, ranks the new results, and provide these results to the user as described above.

In an embodiment, the results include explainability data associated with the resolution this data explains the results in terms of the context and results popularity. In an embodiment, methods utilize the domain ontology for a faceted search using the entity and context data from the original query as well as an additional entity and context data, including resolution data, from the original query search results. In an embodiment, methods utilize the ranked results from the reformulated query to further refine or further reformulate the query, yielding a second reformulated query, for which the method retrieves an additional set of results, which the method then ranks and provides to the user, as described above.

In an embodiment, methods define a data masking policy for input data. Logs typically include a template with variables that are populated based on an environment. Some of these environmental parameters may not be relevant for problem diagnosis. The logs may include exception data which may indicate that an environmental variable would be relevant to problem diagnosis as problem resolutions for the same message code may vary according to the differing exceptions for the cases. The masking policy masks the irrelevant environmental parameters while retaining the visibility of the log exceptions data. Such a masking policy includes identifying query entities to be masked and those to be extracted. Application of such a policy to an input query yields a modified query having at least one masked entity. As an example, an input query may include a message code of a form indicating that it is environmentally generated—such as an environmentally generated serialized identifier—and therefore has no benefit in diagnosing this problem or future problems as all such future message codes, even those for an identical problem, will differ. A masking policy leads to such a message code being masked before entity extraction.

In an embodiment, methods define one or more policies relating to entity types of interest to be extracted from input queries. Methods define such policies according to the entities of interest present in the knowledge domain ontology. Similarly, methods define context usage policies according to contexts associated with the entities of interest in the knowledge domain ontology.

In an embodiment, after receiving an input query, methods identify the source of the query, (e.g., log anomaly, metric anomaly, alert, natural language query, etc.). Methods extract entities from the query such as message codes, path, IP address, filename, servername, resource, components, etc. according to NLP and defined system policies. For potentially masked entities, methods check mask policy exceptions and extract otherwise masked entities according to the policy exceptions.

In an embodiment, methods gather context for the extracted entities, Such context includes the direct context—the other text present in the input query, as well as derived context wherein the method, leverages the defined domain ontology and an included message code taxonomy to extract a relationship type and degree of relationship between a currently extracted message code and a related message code. For an explicitly strong relationship between message codes, the context for the strongly related message code may be leveraged to augment the query. In an embodiment, methods use the knowledge domain to predict a context for the extracted entities.

In an embodiment, methods include context usage policies defined according to the current method activity. For example, for reformulating a query, the method may use the direct context for the extracted entities. For providing explainability of a problem resolution, the method may utilize the direct context and borrow or otherwise associated context from other related message codes. For re-ranking previous query results, the method may utilize the direct context.

In an embodiment, methods receive an input query from a user and select a retrieval engine according to the source of the query. The method augments the original query with additional context from the domain ontology and retrieves new results for the query, ranks the results, and provides the ranked results to the user, together with the explanation for the results. In this embodiment, the method may re-rank the results according to the order of the results, the context of the entities, and user feedback regarding the original ranking order. The method provides context and popularity data for the results for the explanation, more popular results may be ranked higher, and results similar to previous highly ranked results having a similar context may be ranked higher.

In an embodiment, methods define policies for weighing feedback received for provided ranked results. Such policies may include consideration of factors including, a user's profile—more weight given to feedback of an SME than to that of a new user; the number of cases resolved by the user; the duration of the current case; the complexity of the current case, for example, the number of associated message codes; the involvement of support engineers, the source of the solution, the time between similar incident reoccurrences on the same system, the actual resolution of the case, and the input signal source associated with the feedback.

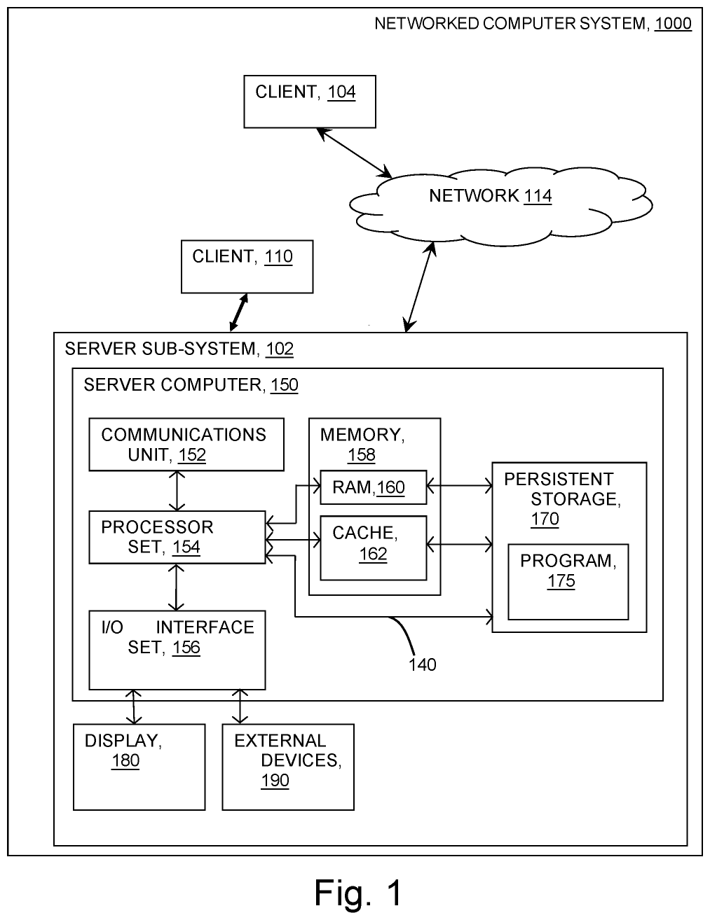

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise a knowledge derivation program (not shown) together with sufficient computing resources (processor, memory, network communications hardware) to execute the program. As shown in FIG. 1, server sub-system 102 comprises a server computer 150. FIG. 1 depicts a block diagram of components of the server computer 150 within a networked computer system 1000, in accordance with an embodiment of the present invention. It should be appreciated that FIG. 1 provides only an illustration of one implementation and does not imply any limitations regarding the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications, and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the knowledge derivation program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., knowledge derivation program 175 on server computer 150, can be stored on a such portable computer-readable storage media and can be loaded onto persistent storage 170 via I/O interface(s) 156. I/O interface(s) 156 also connects to a display 180.

Display 180 provides a mechanism to display data to a user and may be, for example, a computer monitor. Display 180 can also function as a touch screen, such as a display of a tablet computer.

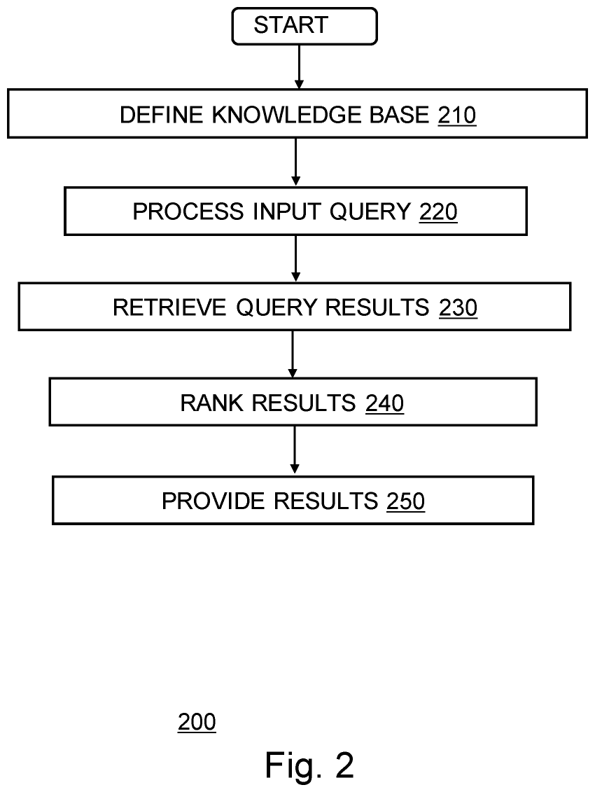

FIG. 2 provides a flowchart 200, illustrating exemplary activities associated with the practice of the disclosure. After the program start, at block 210, methods define a knowledge base by extracting a plurality of entities, such as problem codes, or problem resolutions, and associated metadata, from multiple corpora. The methods build the knowledge base by defining relationships and policies associated with the entities and relating metadata to entities across multiple corpora. Methods rank the augmented entities, and problem resolutions, and store the ranked entities together with associated metadata, and problem resolution explanations.

At block 220, methods process an input query by identifying a source for the query, extracting at least one entity from the language of the query, identifying a context for the entity and query, and reformulating the query according to the input source, the context, the entity, and the defined knowledge base.

At block 230, knowledge derivation methods retrieve results from a retrieval engine associated with the query source and/or the knowledge base. At block 240, methods rank the results according to the order of the results, the context and user feedback regarding previous similar results. At block 250, methods provide ranked results to the source of the query, together with an explanation of the results in terms of query context and results popularity. In an embodiment, results recipients utilize the results for the purpose of resolving the current system issues.

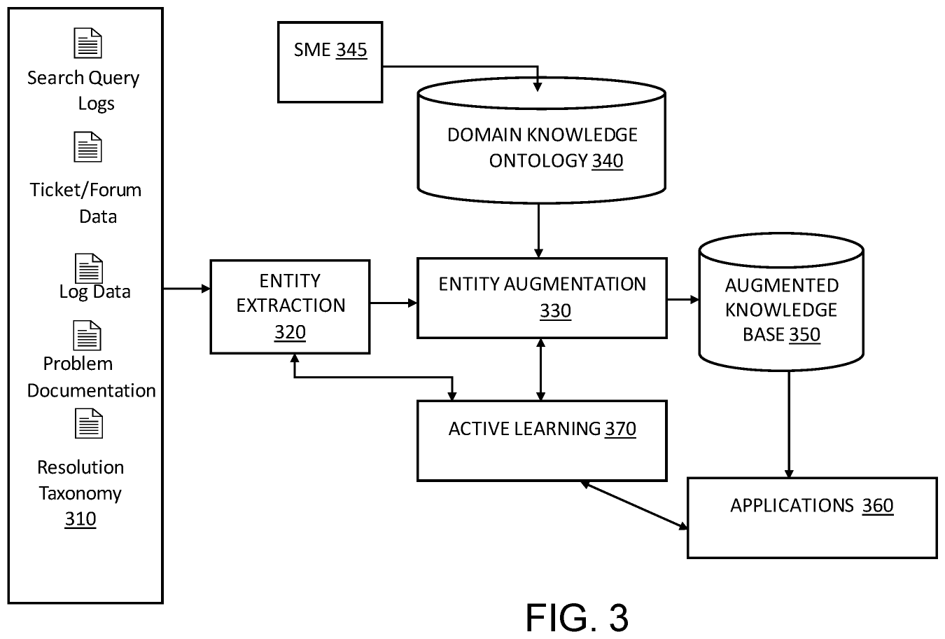

FIG. 3 provides a block diagram depicting data flow for an embodiment of the invention. As shown in the figure, entity extraction 320, occurs across a variety of siloed data sources 310, including Search Query Logs, Ticket/Forum Data, Log Data, Problem Documentation, and Resolution Taxonomy, etc.

Extracted entity augmentation at 330, includes the use of the domain knowledge ontology 340, which local domain Subject Matter Experts 345, curate. Methods normalize and map sematic embeddings of the extracted entities using the ontology 340. Augmentation may include the identification of same-as relationships between entities extracted from the siloed data sources. Augmentation further benefits and utilizes active learning 370 which utilizes machine learning to identify entity relationship patterns over time.

In an embodiment, the method receives user feedback indicating the usefulness of a provided method output, such as detected entities, document resolutions, query formulations, etc. The method utilizes the received feedback and backpropagation to modify the training dataset, resulting in a modified training dataset. The method then trains the model using the revised training dataset, finetuning the model weights according to the received feedback. The training yields a fine-tuned model which will provide a corrected output for identical future input.

As an example, Entity Detection is a sequence labeling algorithm that is either (Hidden Markov Model) HMM or (Condition Random Field) CRF. The algorithm detects an entity for one of the tokens in a log line that the user indicates is not correct. The method utilizes the identified log line, along with the corrected entity label, as input to the HMM or CRF algorithm to retrain the model. The method then recomputes the evaluation metrics to ensure that model performance does not drop.

Augmented knowledge base 350 results from the entity augmentation process. The augmented knowledge base 350 provides a source for applications 360 in the formulation or augmentation of user activities such as queries, using a user query as a starting point. Other user activities/applications include completing partial user queries, ranking and re-ranking query results according to augmented entities, faceted search es based upon the augmented entities, and providing results explainability for the search query results.

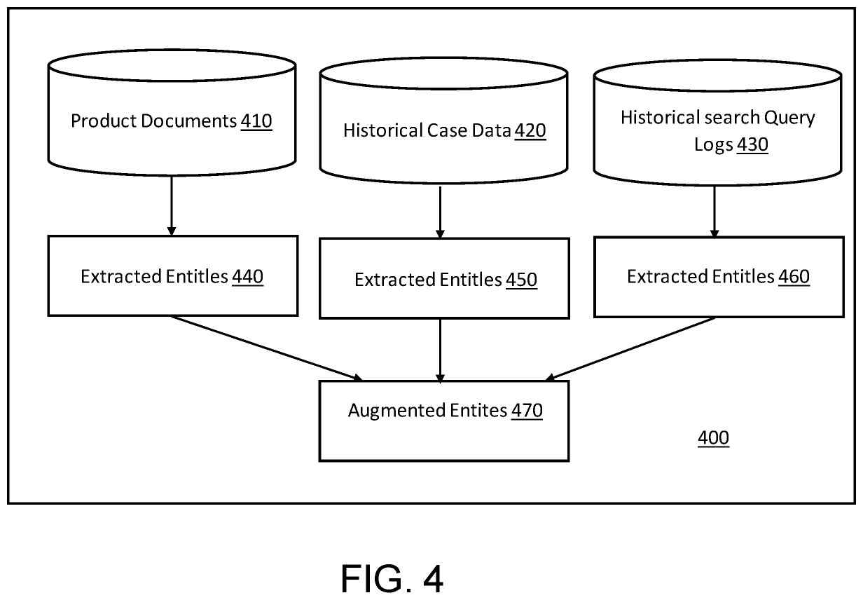

FIG. 4 illustrates example 400, of augmented knowledge derivation. As shown in the figure, methods extract entities, 430, 440, and 450, from disparate data silos, such as product documents 410, historical case data 420, and historical search query logs 430. Such entities may include “title”: “<title of the document>”; “symptom description”: “<symptom is being addressed>”; “resolution”: “<diagnostic steps and actions to be taken>”; “resolution_url”: https://123; and “classification”:{“category”,“sub-category”, “operating_system”: rhel, xp, “product_version”, “product_description”, “last_modified_date”, “document_popularity” }. Disclosed methods may then generate or derive the augmented entity 470, including associated entites “last modified date”, document popularity”, “System hang|app unresponsive|server out of memory, rhel;redhat|windows;xp, websphere version: 8.0|9.0, based upon the curated domain knowledge ontology and the active learning modules.

In an embodiment, the augmented entities may then be passed to applications for use in altering or completing queries, formulating faceted searches, providing results explanations, ranking results or re-ranking previously obtained results.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

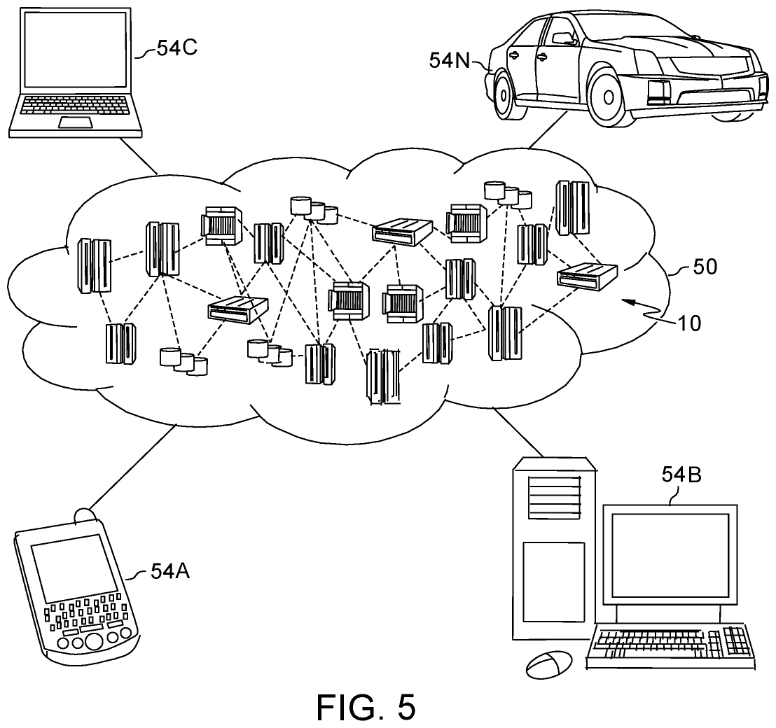

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

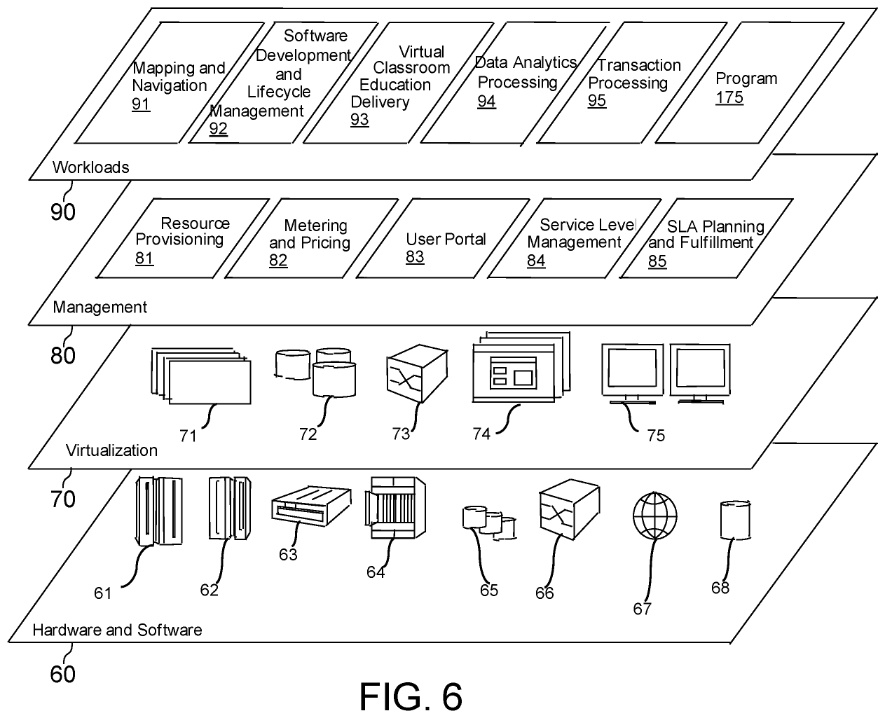

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and knowledge derivation program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for deriving augmented knowledge from a plurality of heterogeneous data sources, the method comprising:
defining, by one or more computer processors, a knowledge base by:
extracting entities from a plurality of heterogeneous data sources; and
augmenting the extracted entities; and
utilizing an augmented entity to enhance a user activity.

2. The method according to claim 1, the method comprising:
defining, by one or more computer processors, a knowledge base by:
extracting a plurality of problem resolutions;
augmenting the problem resolutions with associated metadata;
ranking the plurality of problem resolutions augmented with the associated metadata; and
storing the problem resolutions augmented with the associated metadata and ranked, together with associated problem resolution explanations;
processing, by the one or more computer processors, an input query by:
identifying a source of the input query;
extracting at least one entity from query language;
identifying context data associated with the input query;
retrieving, by the one or more computer processors, results from the knowledge base for the input query and context;
ranking, by the one or more computer processors, the results; and
providing, by the one or more computer processors, the results together with an explanation of the ranking.

3. The method according to claim 2, further comprising defining, by the one or more computer processors, at least one of a data masking policy, an entity type policy, and a context usage policy.

4. The method according to claim 2, further comprising ranking, by the one or more computer processors, the results according to at least one of results order, results context, and user feedback.

5. The method according to claim 2, further comprising expanding, by the one or more computer processors, the input query according to a unique problem identifier of the input query.

6. The method according to claim 1, further comprising altering at least one of the entity extraction and the domain knowledge ontology using active learning.

7. The method according to claim 1, further comprising altering at least one of the entity extraction and the domain knowledge ontology according to system usage.

8. A computer program product, the computer program product comprising one or more computer readable storage devices and stored program instructions on the one or more computer readable storage devices, the stored program instructions comprising:
program instructions to define a knowledge base by:
extracting entities from a plurality of heterogeneous data sources; and
augmenting the extracted entities; and
program instructions to utilize an augmented entity to enhance a user activity.

9. The computer program product according to claim 8, the stored program instructions further comprising:
program instructions to define a knowledge base by:
extracting a plurality of problem resolutions;
augmenting the resolutions with associated metadata;
ranking the plurality of problem resolutions augmented with associated metadata; and
storing the problem resolutions augmented with associated metadata and ranked, together with associated problem resolution explanations;
program instructions to process an input query by:
identifying a source of the input query;
extracting at least one entity from query language;
identifying context data associated with the input query;
program instructions to retrieve results from the knowledge base for the input query and context;
program instructions to rank the results; and
program instructions to provide the ranked results together with an explanation of the ranking.

10. The computer program product according to claim 9, the stored program instructions further comprising program instructions to define at least one of a data masking policy, an entity type policy, and a context usage policy.

11. The computer program product according to claim 9, wherein identifying context comprises at least one of gathering context, predicting context, and identifying context according to a usage scenario.

12. The computer program product according to claim 9, the stored program instructions further comprising program instructions to rank the results according to at least one of results order, results context, and user feedback.

13. The computer program product according to claim 8, the stored program instructions further comprising program instructions to alter at least one of entity extraction and the domain knowledge ontology using active learning.

14. The computer program product according to claim 8, the stored program instructions further comprising program instructions to alter at least one of entity extraction and the domain knowledge ontology according to system usage.

15. A computer system, the computer system comprising:
one or more computer processors;
one or more computer readable storage devices; and
stored program instructions on the one or more computer readable storage devices for execution by the one or more computer processors, the stored program instructions comprising:
program instructions to define a knowledge base by:
extracting entities from a plurality of heterogeneous data sources; and
augmenting the extracted entities; and
program instructions to utilize an augmented entity to enhance a user activity.

16. The computer system according to claim 15, the program instructions further comprising:
program instructions to define a knowledge base by:
extracting a plurality of problem resolutions;
augmenting the resolutions with associated metadata;
ranking the plurality of problem resolutions augmented with associated metadata; and
storing the problem resolutions augmented with associated metadata and ranked, together with associated problem resolution explanations;
program instructions to process an input query by:
identifying a source of the input query;
extracting at least one entity from query language;
identifying context data associated with the input query;
program instructions to retrieve results from the knowledge base for the input query and context;
program instructions to rank the results; and
program instructions to provide the ranked results together with an explanation of the ranking

17. The computer system according to claim 16, the stored program instructions further comprising program instructions to define at least one of a data masking policy, an entity type policy, and a context usage policy.

18. The computer system according to claim 16, wherein identifying context comprises at least one of gathering context, predicting context, and identifying context according to a usage scenario.

19. The computer system according to claim 15, the stored program instructions further comprising program instructions to alter at least one of entity extraction and the domain knowledge ontology using active learning.

20. The computer system according to claim 15, the stored program instructions further comprising program instructions to alter at least one of the entity extraction and the domain knowledge ontology according to system usage.
